(19) United States
(12) Patent Application Publication
(10) Pub. No.: US 2006/0109071 A1
(43) Pub. Date: May 25, 2006

(54) Circuit board inductor

(76) Inventors: Christopher H. Thongsouk, Alpharetta, GA (US); David M. DeMuro, Lawrenceville, GA (US); Roy L. Kerfoot JR., Lilburn, GA (US); John W. Oglesbee, Watkinsville, GA (US)

Correspondence Address: MOTOROLA, INC.;LAW DEPARTMENT, 600 NORTH U.S. HIGHWAY 45, AS437, LIBERTYVILLE, IL, 60048, US

(21) Appl. No.: 10/993,816

(22) Filed: Nov. 19, 2004

(51) Int. Cl. H01F 5/00

(52) U.S. Cl. 336/200

(57) ABSTRACT

A magnetic component, like an amorphous metal ribbon component, is disposed within an aperture of a layer of circuit board substrate, like FR4 or a flexible substrate. That layer is then laminated between a top and bottom layer to form a circuit substrate with a magnetic component integrally formed therein. Conductive traces are disposed on the top layer and bottom layer. These conductive traces are coupled together about the magnetic component with conductive vias. The top traces, bottom traces and conductive vias form a “winding” about the magnetic component. The resultant assembly is a single, multi-layered circuit substrate with a magnetic circuit element integrally formed therein. The magnetic circuit component is suitable for use as, amongst other things, an inductor, a transformer, or a contactless charging primary or secondary coil.

### BACKGROUND

1. Technical Field

This invention relates generally to electronic assemblies, and more specifically to an inductor formed integrally with a printed circuit board.

2. Background Art

Contactless, or inductive, electrical connections are well known in the field of portable electrical devices. For example, portable, motorized toothbrushes typically contain a rechargeable battery which is charged by an inductive connection. Similarly, portable wireless communication devices, such as two-way RF radios, cellular phones, paging devices, and wireless communicators, sometimes utilize a rechargeable battery that in certain applications is recharged by contactless, induction charging.

Most all contactless chargers charge batteries by induction. Current, passed through a coil, creates a magnetic flux in accordance with Ampere's law. When a second coil is placed in close proximity to such a current-driven coil, the flux couples to the second coil, thereby “inducing” a current in the second coil. Such an induction circuit is illustrated in FIG. 1.

Turning now to FIG. 1, an inductively coupled charging system 100 has a primary side or base device 112 and a secondary side or portable device 116. A primary controller used as a primary charging device 111 as would be well known to one of ordinary skill in the art, is shown connected to the AC power source and to a primary coil 113. The primary coil 113 is shown inductively coupled to secondary coil 115 by field 114. The secondary coil 115 is coupled to battery 121 through a secondary charging device which is shown in this example as a rectifier circuit 119. The battery 121 in turn is connected to the load shown as RL 123. As would be well known to one of ordinary skill in the art, the energy coupled from the primary coil 113 is applied through the secondary coil 115 to charge the battery 121.

The problem with traditional contactless charging schemes is that electronic devices, like cellular telephones, are getting smaller every day. For instance, the RAZR™ V3 phone, manufactured by Motorola, Inc., is less than a quarter of an inch thick. Traditional secondary coils used in contactless charging systems are made by wrapping wire about an iron core. These cores often measure a half inch or more in thickness. Consequently, thin devices like the RAZR™ V3 are not able to accommodate contactless charging systems due to the fact that the physical size of the secondary coil is larger than the form factor of the phone.

There is thus a need for an improved, smaller secondary coil that may be used in contactless charging systems.

### BRIEF DESCRIPTION OF THE DRAWINGS

FIG. 1 illustrates a prior art contactless charging system.

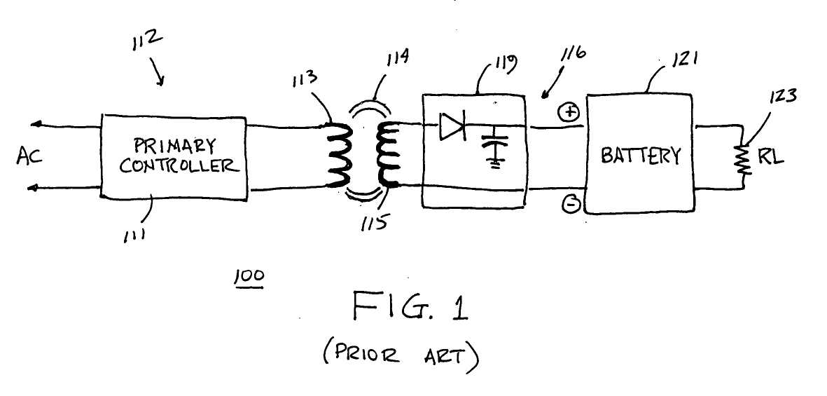

FIG. 2 illustrates one embodiment of a substrate assembly in accordance with the invention.

FIG. 3 illustrates one embodiment of an electronic assembly in accordance with the invention.

FIG. 4 illustrates a sectional view of another embodiment of an electronic assembly in accordance with the invention.

FIG. 5 illustrates another embodiment of an electronic assembly in accordance with the invention.

FIG. 6 illustrates another embodiment of an electronic assembly in accordance with the invention.

FIG. 7 illustrates another embodiment of an electronic assembly in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention is an inductive component that can be manufactured integrally with a circuit substrate like a printed circuit board. A magnetic core material, like an amorphous metal ribbon, is laminated between the layers of an electronic circuit substrate, like a printed wiring board (PWB) or flexible substrate. The finished assembly then has the magnetic core material fixed within in the center of a multi-layered PWB or flexible substrate. The top and bottom layers have conductive traces disposed thereon, wherein the conductive trace patterns each resemble one half of a wire winding that would be on a traditional iron core. The conductive traces on the top and bottom layers are connected about the magnetic core material with conductive vias, which are metallized holes running through the layers of the PWB or flexible substrate. The combined substrate, magnetic core material, traces and connecting vias create a thin, easy to manufacture electronic assembly that may be used as an inductor, transformer, primary coil for contactless charging or secondary coil for contactless charging.

In other embodiments of the invention, the PWB or flexible substrate may be made larger than the magnetic material such that electronic circuits, traces and components may be populated on the outer surfaces of the substrate. In these embodiments, complete circuit assemblies, including circuitry, contact blocks and integral magnetic components can be manufactured on a single printed circuit board (PCB). (A PCB differs from a PWB in that the printed circuit board includes populated electronic components, while the printed wiring board is the substrate itself.)

In alternate embodiments, one or more additional layers may be added to the three-layer core assembly. The outer layers of the final assembly are then suitable for population with electronic components and circuitry. When outer layers are used, the traces about the magnetic material may be disposed upon inner layers of the assembly, thereby leaving more space for components on the outer layer. One example of such an assembly might be where the plastic housing of the device has a curved form factor rather than the typical flat housing. In such applications, an air gap results between the PCB and the plastic housing. The surface mount components may then be placed on the outer layers of the substrate within the air gap.

This invention is ideally suited for use as a secondary coil in inductive charging systems, but other devices can be accommodated as well. For example, the integrated magnetic circuit assembly may be constructed as a transformer where the primary coil, the secondary coil, primary winding and secondary winding are integrally formed within single, multi-layer substrate. As such, the invention facilitates a very thin, low profile transformer. By adding electronic circuitry and components on the outer layers, one may construct complete power supply on a single PCB assembly.

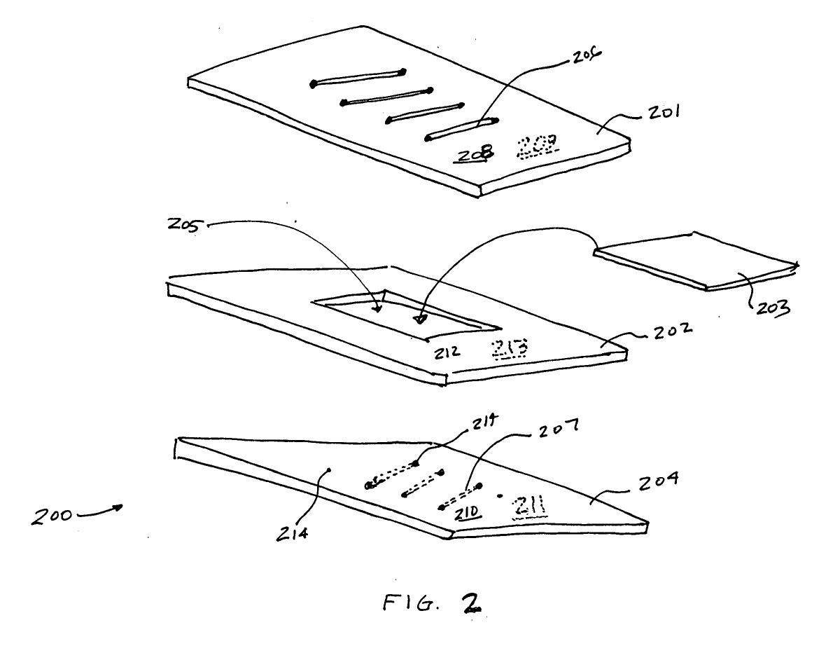

Turning now to FIG. 2, illustrated therein is a basic PWB assembly 200 in accordance with the invention. A first, or top layer 201 of substrate material has a first major surface 208 and a second major surface 209 (opposite the first major surface 208, as indicated with the dotted reference designator). The substrate material may be rigid or flexible, as design applications warrant. One example of a suitable rigid substrate material is FR4, which stands for “Flame Retardant” type-4 material, the type-4 indicating woven glass reinforced epoxy resin. One example of a flexible substrate is Kapton polyamide film. Other selections of substrate material will be obvious to those of ordinary skill in the art who have the benefit of this disclosure.

Conductive electrical traces 206 are disposed on the first layer 201. In the embodiment of FIG. 2, the traces 206 are disposed on the first major surface 208 of the first layer 201. A second, or bottom layer 204 of substrate material has conductive traces 207 disposed on the second major surface 211.

A third, or center layer 202 has an aperture 205 therein. A piece of magnetic material 203, which is comparably shaped with the aperture 205 in the third layer 202 is disposed within the aperture 205. The magnetic material 203 preferably has a Curie temperature that is higher than the temperatures experienced in the substrate lamination process, which are around 150 degrees centigrade. Suitable examples of materials for the magnetic component are amorphous metal ribbon as is known in the art, ferrite material in a suitable binder or magnetic steel lamination material.

The magnetic material 203 is secured within the aperture 205, and the third layer 202 is laminated between the first layer 201 and the second layer 204 such that the first major surface 212 of the third layer 202 is attached to the second major surface 209 of the first layer 201, and the second major surface 213 of the third layer 202 is attached to the first major surface 210 of the second layer 204.

Metallized, conductive vias 214 may be used to couple the traces 206 on the first layer 201 with the traces on the second layer 204. Conductive vias 214 are drilled holes that tunnel through the layers 201,202,204 which have been plated with a conductive, metal material like aluminum or copper. It will be clear to those of ordinary skill in the art having the benefits of this disclosure that other devices, like rivets, may be substituted for plated vias. In either event, by coupling the top traces 206 with the bottom traces 207 with vias 214 about the magnetic material 203, a circumfluent, conductive path that equates to the “windings” about an inductor may be made integrally with the PWB assembly 200.

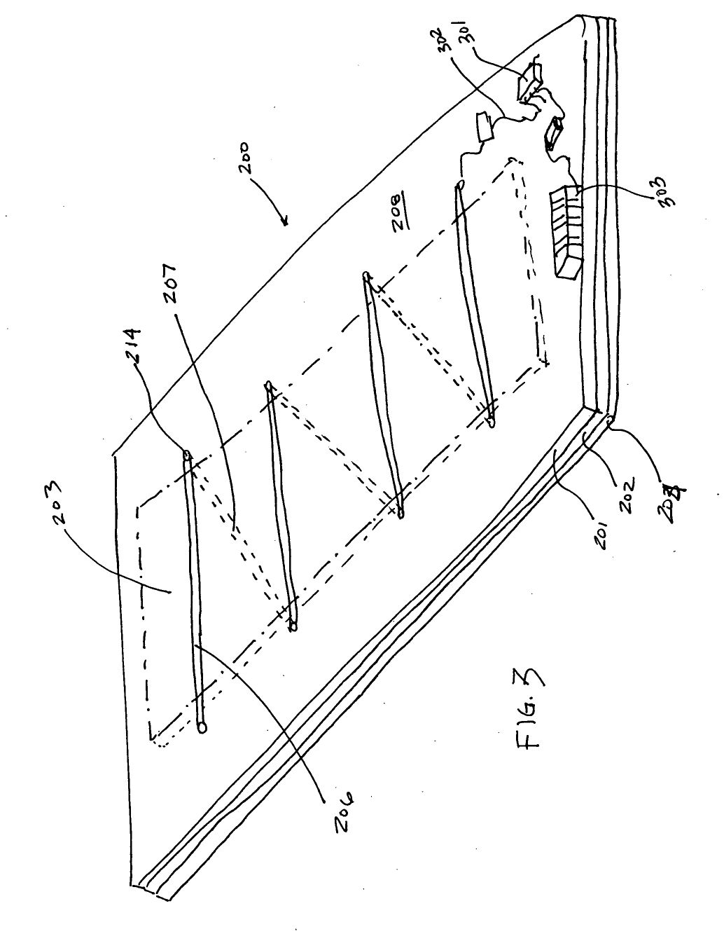

Turning now to FIG. 3, illustrated therein is a completed PWB assembly 200. The layers of substrate 201,202,204 have been laminated together so as to form a single, multi-layered assembly. The top traces 206 have been coupled to the bottom traces 207 with conductive vias 214 so as to form a winding about the magnetic component 203. Since the PWB assembly 200 is formed from substrate material, electrical circuitry including electrical components 301, circuit traces 302 and contact blocks 303 may be disposed on the outer major surfaces, e.g. 208, of the PWB assembly 200 so as to form a PCB assembly.

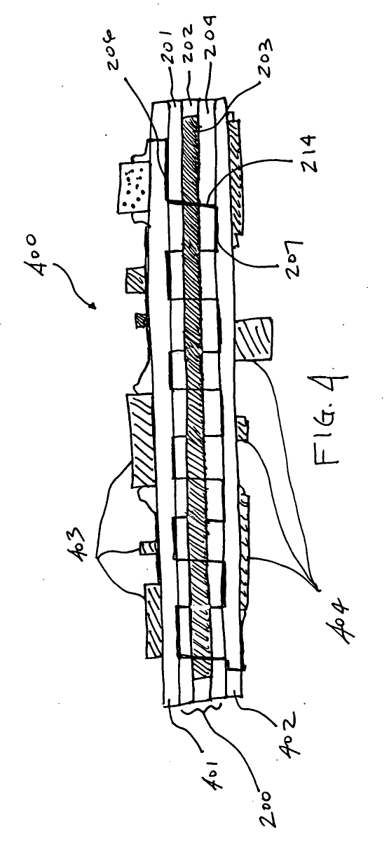

Turning now to FIG. 4, illustrated therein is an alternate embodiment of a PCB assembly 400 in accordance with the invention. The core assembly 200 (as seen in FIGS. 2 and 3) is present, including the first layer of substrate 201, second layer of substrate 204, third layer of substrate 202 and magnetic material 203. Top traces 206 are coupled to bottom traces 207 with conductive vias 204 so as to form a winding about the magnetic material 203.

In the embodiment of FIG. 4, additional outer layers 401,402 have been laminated about the core assembly 200. An upper outer layer 401 and a lower outer layer 402 have been laminated to the first, second and third layers 201,204,202. The upper outer layer 401 and lower outer layer 402 provide additional surface area on the major surfaces that may be populated with electrical components 403,404.

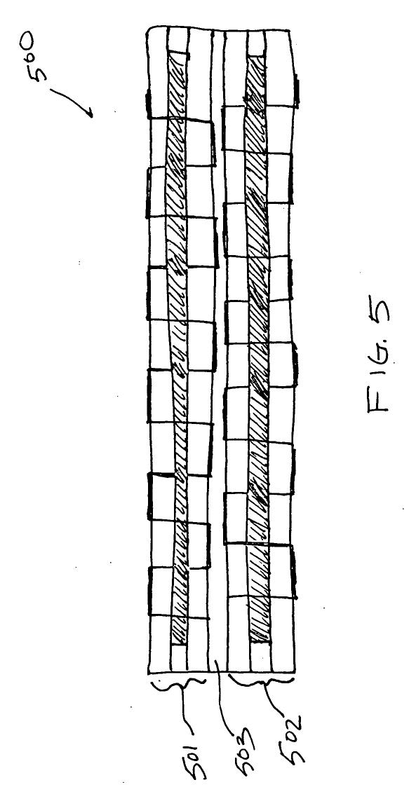

It will be clear to those of ordinary skill in the art having the benefit of this disclosure that various combinations of outer layers and core assembly layers may be attached together. Turning now to FIG. 5, one such exemplary assembly 500 is shown. In this assembly 500, a first core assembly 501 is coupled to a lower outer layer 503. The lower outer layer 503 is then coupled to a second core assembly 502. In such a configuration, the lower outer layer 503 may serve as an insulating layer between the multiple core assemblies 501,502. As noted, numerous combinations of core assemblies and outer layers will be obvious to those of ordinary skill in the art having the benefit of this disclosure.

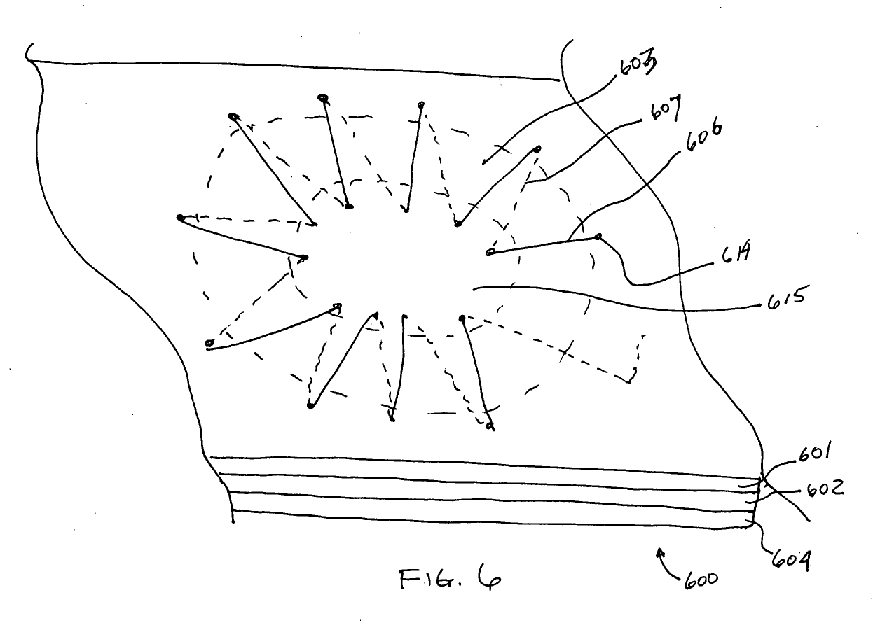

Turning now to FIG. 6, illustrated therein is an alternate embodiment of the invention. In FIG. 6, the magnetic component 603 has an aperture 615 disposed therein. As with the embodiments described above, the magnetic component 603 is positioned within an aperture in the center layer 602 of the assembly 600. The center layer 602 is laminated between the top layer 601 and the bottom layer 604. By coupling top traces 606 and bottom traces 607 with conductive vias 614 both in the aperture 615 of the magnetic component 603 and outside the magnetic component 603, a “toroidal” inductor can be manufactured.

Additionally, rather than using a single set of traces 606,607 to create a single “winding”, multiple sets of interleaved, bifilar windings may also be “wrapped” about the magnetic component 603 to create a transformer. It will be clear to those of ordinary skill in the art having the benefit of this disclosure that tri-filar, quadrafilar, or n-filar windings could additionally be used to form transformers with 3, 4 or n windings, respectively.

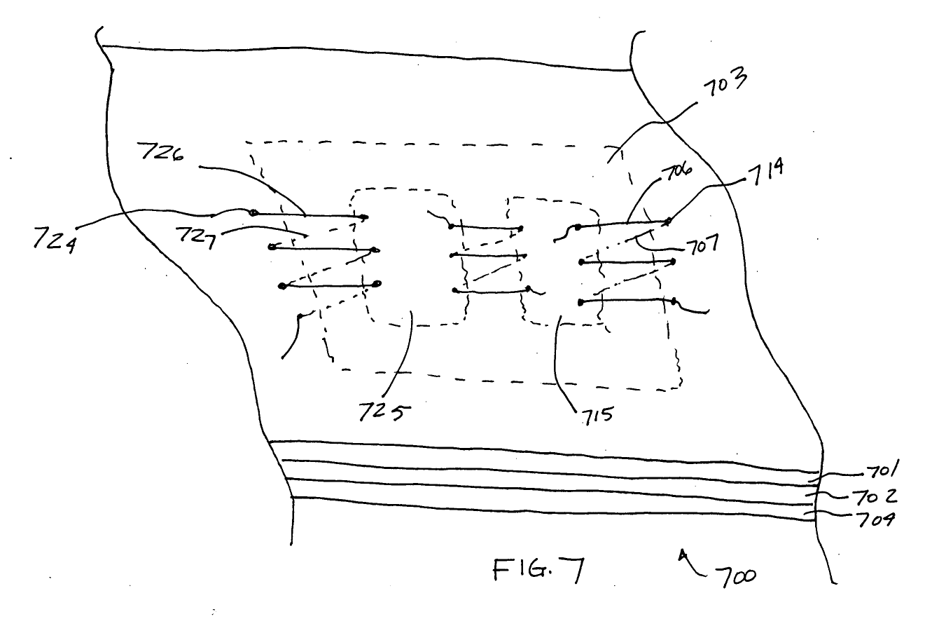

Turning now to FIG. 7, illustrated therein is another embodiment of the invention. In this embodiment, the invention has been employed to make a transformer that is integrated into a single, multi-layer assembly 700. The magnetic component 703, which is placed within an aperture of the central layer 702 and laminated between a top layer 701 and a bottom layer 704, has a pair of apertures 715,725. The magnetic component 703 with these two apertures 715,725 resembles the cross section of a conventional transformer with a center leg. It will be clear to those of ordinary skill in the art that magnetic components with other shapes, including one, two, three or more apertures, could equally be used in the transformer application.

In the transformer assembly 700, a first set of top traces 706 and a second set of top traces 726 are disposed on the top layer 701. The first set of top traces 706 and a second set of top traces 726 are electrically disconnected so as to provide the isolation associated with a transformer. Similarly, a first set of bottom traces 707 and a second set of bottom traces 727 are disposed on the bottom layer 704.

The first set of top traces 706 and the first set of bottom traces 707 are coupled with a first set of conductive vias 714 about one leg of the magnetic component 703. Similarly, the second set of top traces 726 and the second set of bottom traces 727 are coupled with a second set of conductive vias 724 about another leg of the magnetic material 703. In so doing, a transformer assembly 700 is created with the magnetic component serving as the magnetic flux conduit. The first set of top traces 706, first set of bottom traces 707 and first set of conductive vias 714 form one winding of the transformer, and the second set of top traces 726, second set of bottom traces 727, and second set of conductive vias 724 form the second winding.

To summarize, the invention includes electronic assembly having a substrate assembly, wherein the substrate assembly has at least three layers of substrate material. Each layer of the substrate assembly has a first and a second major surface. The three layers include a first layer that has conductive traces disposed on the first major surface. The second layer has conductive traces disposed on the second major surface. The third layer has an aperture, and the first major surface of the third layer is attached to the second major surface of the first layer. The second major surface of the third layer is attached to the first major surface of the second layer.

A magnetic material, like an amorphous metal ribbon component, has a shape that is comparable with the aperture in the third layer. During manufacture, the magnetic material is first disposed within the aperture of the third layer. This magnetic component/third layer assembly is then laminated between the first and second layers. The traces on the first and second layers are then coupled with metallized, conductive vias that run through the multi-layered assembly. The result is a PWB that includes an integral magnetic component suitable for use as an inductor, transformer, or contactless charging primary or secondary coil.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while one application for this invention is contactless charging, numerous other applications, including EMI suppression, power conversion, electrical isolation and filtering are equally suitable for the invention.

1. An electronic assembly, comprising:
a. a substrate assembly, the substrate assembly comprising at least three layers of substrate material, each layer having a first and second major surfaces, wherein the at least three layers comprise:
i. a top layer having conductive traces disposed thereon;
ii. a bottom layer having conductive traces disposed thereon;
iii. a central layer having an aperture therein;
b. at least one magnetic component, the at least one magnetic component being comparably shaped to the aperture in the central layer; and
c. conductive vias coupling the conductive traces disposed on the top layer with the conductive traces disposed on the bottom layer.

2. The assembly of claim 1, wherein the magnetic component has a Curie temperature above 150 degrees centigrade.

3. The assembly of claim 1, wherein the magnetic component is selected from the group consisting of amorphous metal ribbon, ferrite and laminated magnetic steel.

4. The assembly of claim 1, further comprising electrical circuitry disposed upon either the top layer or bottom layer.

5. The assembly of claim 1, further comprising an upper outer layer and a lower outer layer, wherein the top, bottom and central layers are disposed between the upper outer layer and lower outer layer.

6. The assembly of claim 5, further comprising electrical circuitry disposed on either the upper outer layer or lower outer layer.

7. The assembly of claim 1, wherein the top, bottom and central layers are manufactured from a material selected from the group consisting of rigid circuit board substrates and flexible circuit board substrates.

8. The assembly of claim 1, wherein the conductive traces disposed on the top layer comprise a first set of top layer traces and a second set of top layer traces, further wherein the conductive traces disposed on the lower layer comprise a first set of bottom layer traces and a second set of bottom layer traces.

9. The assembly of claim 8, wherein the first set of top layer conductive traces is coupled to the first set of bottom layer traces with a first set of conductive vias, further wherein the second set of top layer traces is coupled to the second set of bottom layer traces with a second set of conductive vias.

10. The assembly of claim 9, wherein the magnetic component has an aperture therein.

11. An electronic assembly, comprising:
a. a substrate assembly, the substrate assembly comprising at least three layers of substrate material, each layer having a first and second major surfaces, wherein the at least three layers comprise:
i. a first layer having conductive traces disposed on the first major surface;
ii. a second layer having conductive traces disposed on the second major surface;
iii. a third layer having an aperture therein, wherein the first major surface of the third layer is attached to the second major surface of the first layer, further wherein the second major surface of the third layer is attached to the first major surface of the second layer;
b. at least one amorphous metal ribbon component, the at least one amorphous metal ribbon component being comparably shaped to the aperture in the third layer; and
c. conductive vias coupling the conductive traces disposed on the first layer with the conductive traces disposed on the second layer.

12. The assembly of claim 1, further comprising electrical circuitry disposed upon either the first layer or second layer.

13. The assembly of claim 11, further comprising at least an upper outer layer and a lower outer layer, wherein the first, second and third layers are disposed between the upper outer layer and lower outer layer.

14. The assembly of claim 13, further comprising electrical circuitry disposed on either the upper outer layer or lower outer layer.

15. The assembly of claim 11, wherein the first, second and third layers are manufactured from a material selected from the group consisting of rigid circuit board substrates and flexible circuit board substrates.

16. The assembly of claim 11, wherein the conductive traces disposed on the first layer comprise a first set of first layer traces and a second set of first layer traces, further wherein the conductive traces disposed on the second layer comprise a first set of second layer traces and a second set of second layer traces.

17. The assembly of claim 16, wherein the first set of first layer conductive traces is coupled to the first set of second layer traces with a first set of conductive vias, further wherein the second set of first layer traces is coupled to the second set of first layer traces with a second set of conductive vias.

18. The assembly of claim 17, wherein the amorphous ribbon metal component has an aperture therein.

19. An electronic assembly, comprising:
a. a substrate assembly, the substrate assembly comprising at least three layers of substrate material, each layer having a first and second major surfaces, wherein the at least three layers comprise:
i. a first layer having conductive traces disposed on the first major surface;
ii. a second layer having conductive traces disposed on the second major surface;
iii. a third layer having an aperture therein, wherein the first major surface of the third layer is attached to the second major surface of the first layer, further wherein the second major surface of the third layer is attached to the first major surface of the second layer; and
b. at least one amorphous metal ribbon component, the at least one amorphous metal ribbon component being comparably shaped to the aperture in the third layer;
wherein the electronic assembly is manufactured by disposing the amorphous metal ribbon component within in aperture of the third layer, laminating the third layer between the first and second layer, and coupling the conductive traces disposed on the first layer with the conductive traces disposed on the second layer with conductive vias.
